(19) United States
(12) Patent Application Publication
(10) Pub. No.: US 2008/0292933 A1
(43) Pub. Date: Nov. 27, 2008

(54) FUEL CELL MEMBRANE ELECTRODE ASSEMBLY WITH HIGH CATALYST EFFICIENCY THEREOF

(75) Inventors: Tzyy-Lung Leon YU, Jhongli City (TW); Hsiu-Li Lin, Jhongli City (TW); Guan-Wen Wang, Jhongli City (TW); Shih-Hung Chan, Jhongli City (TW)

Correspondence Address: Muncy, Geissler, Olds & Lowe, PLLC, P.O. BOX 1364, FAIRFAX, VA, 22038-1364, US

(73) Assignee: YUAN ZE UNIVERSITY

(21) Appl. No.: 12/050,705

(22) Filed: Mar. 18, 2008

(30) Foreign Application Priority Data
May 23, 2007 (TW) 96118387

(51) Int. Cl. H01M 8/10; H01M 4/96

(52) U.S. Cl. 429/30; 429/40

(57) ABSTRACT

A membrane electrode assembly of a fuel cell comprises a proton exchange membrane, two metal-carbon (carbon supported metal) catalyst layers, two gas diffusion layers and at least two metal catalyst layers. The proton exchange membrane is at the center of the membrane electrode assembly, the two metal-carbon catalyst layers are located on both sides of the proton exchange membrane. The two gas diffusion layers are on both outer surfaces of the membrane electrode assembly. The metal catalyst layers are located at the interface between the proton exchanged membrane and the metal-carbon catalyst layer and/or at the interface between the metal-carbon catalyst layer and the gas diffusion layer. The combinations of metal-carbon catalyst and metal-catalyst layers reduce the thickness of catalyst layer and maintain a high catalysis activity, and thus improve the fuel cells performance.

### RELATED APPLICATIONS

This application claims priority to Taiwan Application Serial Number 96118387, filed May 23, 2007, which is herein incorporated by reference.

### BACKGROUND

1. Field of Invention

The present invention relates to membrane electrode assemblies (MEA) for proton exchange membrane fuel cells (PEMFC). The present invention also relates to the catalysts layers structures of the MEAs of the present invention.

2. Description of Related Art

It is generally accepted that proton exchange membrane (PEM) fuel cells present an attractive alternative to traditional power sources, due to their high efficiency and non-pollution. However, the high cost of the cell components impedes their commercialization. One of the primary contributors to the PEM fuel cell's high cost is the catalyst, platinum (Pt). One of the methods to reduce the catalyst cost of PEM fuel cells is to improve the utilization of catalysts. The most common method for fabricating PEMFC catalyst layers is to mix the carbon supported platinum (Pt—C) agglomerates with solubilised ionomers (for example Nafion ionomer) and apply this paste to a porous carbon support gas diffusion layer (GDL). However, up to 50% of Pt atoms in such electrodes may be inactive [S. D. Thompson, L. R. Jordan, M. Forsyth, Electrochimica Acta, 46, p. 1657 (2001)]. Three important factors controlling catalysts utilization are: (1) catalysis activity of catalysts particles, which depends on the specific surface area of catalysts particles, (2) proton transport resistance in a catalyst layer, which depends on the path-length for proton transport in a catalyst layer, and (3) the ratio of Pt particles in contact with ionic groups of ionomer binder (for example sulfonic acid groups of Nafion resin). The Pt particles with higher specific surface area should have higher catalysis activity. The ionic group aggregations of ionomer binder form pathways facilitating proton transport in catalyst layer. It is necessary that Pt particles are in contact with ionic groups of ionomer binders for proton produced on the Pt particles surfaces to be transported via the ionic aggregations pathways. The area of catalytic reaction zone may be extended by increasing the amount of ionomer throughout the catalyst layer, but too much ionomer coverage on Pt particles may restrict fuel and oxidant gas to access Pt particles. Thus an optimum wt ratio of [Pt]/[ionomer binder] is necessary for a catalyst layer with high proton transport efficiency and for gas reactants to reach each catalyst particle [Z. Xie, T. Navessin, K. Shi, R. Chow, Q. Wang, D. Song, B, Andreaus, M. Eikerling, Z. Liu, S. Holdcroft, J. Electrochem. Soc., 152(6), p. A1171-1179 (2005)]. The other factor controlling proton transport in catalyst layer is the thickness of catalyst layer. Increasing catalyst layer thickness results in an increase in proton transport path length in catalyst layer and thus increases proton transport resistance. In order to obtain a high performance PEM fuel cell, one should increase the catalyst particles specific surface area and reduce the catalyst layer thickness in a MEA under an optimum [Pt]/[ionomer binder] ratio.

In the past two decades, several catalyst layer structures designs and fabrication methods had been reported in literature [M. S. Wilson, S. Gottesfeld, J. Electrochem. Soc., 139, p. L28 (1992); S. Hirano, J. Kim, S. Srinivasan, Electrochimica Acta, 42, p. 1587 (1997); S. Lister, G. McLean, J. Power Sources, 130, p. 61 (2004); U.S. Pat. No. 63,000,000B1]. One of the most widely used conventional catalyst layer structures is structure-a shown in FIG. 1-a. In FIG. 1-a, 502 means PEM, 504 means metal-C (carbon supported metal) catalyst, 508 means GDL. It consists of a metal-C catalyst layer between PEM and GDL. Usually the metal-C is Pt—C and GDL is a porous carbon paper or a porous carbon cloth. The advantage of using Pt—C catalysts instead of Pt catalysts is the reduction of nano-Pt particles agglomeration in the catalyst layer, thus avoid reducing Pt catalytic surface area. The particles sizes of carbon powders of commercialized Pt—C are around 50-80 nm [J. L. Larminie, A. Dicks, Fuel Cells Systems Explained, John Wiley & Sons, Ltd., 2000, p. 6, FIG. 1.6.] and the particles sizes of Pt deposited on the surface of carbon powders increase from 1.5 nm to 4.9 nm (i.e. specific surface area of Pt decreases from 185 m²/g to 57 m²/g), when the amount of Pt deposited on carbon powders surfaces increases from 5 wt % to 80 wt % [F. Barbir, PEM Fuel Cells, Elsevier Academic Press, MA, 2005, p. 90, Table 4; E-Tek Co website: etek-inc.com]. The Pt particles sizes of Pt—C increase with increasing the quantity of Pt deposited on carbon powder surfaces, thus the Pt catalytic specific surface area decreases with increasing the amount of Pt deposited on carbon powders surfaces. At a fixed Pt-loading in a catalyst layer, the fabrication of high Pt content Pt—C powders in MEA decreases both the Pt catalysis activity and the thickness of catalyst layer, because of low content of large carbon particles in catalyst layer. Thus both the Pt catalysis activity and the resistance for proton transport in catalyst layer decrease with increasing Pt content of Pt—C powders. However, the use of low Pt content Pt—C catalysts in MEA causes increments both in Pt catalytic surface area and catalyst layer thickness, because of high content of large carbon particles. The Pt catalytic activity increases but the resistance for proton transport in catalyst layers also increases with decreasing the Pt content of Pt—C. The increase of proton transport resistance in catalyst layers can be attributed to the increment of catalyst layer thickness by increasing loading of large carbon particles. Thus, how to obtain “a MEA comprises of catalyst layers with high catalysis activity and low proton transport resistance” is one of the important issues of the design of MEA catalyst layer structure. Most of researchers use Pt—C particles with a Pt content of 40-50 wt % (Pt particles sizes 2.9 nm-3.3 nm and specific surface area around 110 m²/g-86 m²/g) as catalysts in PEMFC. At a fixed Pt loading, the use of Pt—C catalysts with 40-50 wt % Pt content has a medium Pt catalytic surface area and a medium catalyst layer thickness, and thus an optimum PEM fuel cell performance can be obtained.

An improvement of fuel cell power output by modifying catalyst structure design had been reported in literature. Its structure is similar to structure-a, but with an additional sputtered Pt thin film located between PEM and Pt—C (Pt content 20 wt %) layer [E. A. Ticianelli, C. R. Derouin, S. Srinivasan, J. Electroanal Chem, 251, p. 275 (1988); S. Mukerjee, S. Srinivasan, A. J. Appleby, Electrochimica Acta, 38(12), p. 1661 (1993)]. In here, we call this modified catalyst layers structure by an additional sputtered Pt thin films as structure-as. These authors indicated that sputtering one additional Pt thin film with a Pt loading of 0.05 mg/cm² at the interface between Pt—C layer and PEM (the total Pt loading was 0.45 mg/cm²) could enhance the fuel cell output power of structure-a MEA which consisted of only one Pt—C (Pt content 20 wt %) catalyst layer with a Pt loading of 0.40 mg/cm². One of the reasons of the higher power output of structure-as than structure-a could be due to the higher total Pt loading of structure-as than structure-a. The main disadvantage of the catalyst layer design of structure-as is the increase of catalyst cost by sputtering one additional Pt thin film in structure-a MEA.

The present invention is modifications of structure-a MEA by replacing part of large Pt—C catalyst particles layer with a thin small Pt-black catalyst particles layer. The main purpose is to reduce the catalyst layers thickness and thus reduce the proton transport resistance in catalyst layers and also maintain high Pt catalysis activity to improve fuel cells performance.

### SUMMARY OF THE INVENTION

The present invention is directed to catalyst layers structures of MEAs, which are modifications of catalyst layers of structure-a MEA.

In one aspect, the present invention provides a membrane electrode assembly, comprising a proton exchange membrane; at least two metal-carbon catalyst layers, located on both sides of the proton exchange membrane; two gas diffusion layers attached on the two outer sides of the metal-carbon catalyst layers; and at least one metal catalyst layer, located at the interface between the proton exchange membrane and the metal-carbon catalyst layer and/or at the interface between the metal-carbon catalyst layer and the gas diffusion layer.

According to one embodiment of the present invention, the proton exchange membrane is: Nafion, polybenzoimidazole (PBI), sulfonated poly(ether ketone), sulfonated poly(ether ether ketone), sulfonated polyimide, sulfonated polysulfone, or other polyelectrolytes. The thickness of proton exchange membrane is 5-200 μm.

According to one embodiment of the present invention, the metal-carbon catalyst is a mono-metal-carbon catalyst or a multi-metal-carbon catalyst. The particles sizes of mono-metal-carbon catalysts or the multi-metal-carbon catalysts are 40-150 nm. The multi-metal-carbon catalyst comprises a carbon particle with metal particles dispersed on the surface of the carbon particle. The metal particles of the multi-metal-carbon catalyst comprises at least two kinds of metal elements selected from the group consisting of platinum, gold, cobalt, iron, rubidium, nickel, silver, palladium and a combination thereof The mono-metal-carbon catalyst comprises a carbon particle with metal particles dispersed on the surface of the carbon particle wherein the metal particles comprise only one kind of metal element. The particle size of the metal particles in the multi-metal-carbon catalyst or the mono-metal-carbon catalyst is 1.0-10.0 nm.

According to one embodiment of the present invention, the metal catalyst layer comprises metal particles which are one kind of metal elements or more than one kind of metal elements. The metal particles of the metal catalyst layer are selected from the group consisting of platinum, gold, cobalt, iron, rubidium, silver, palladium, and a combination thereof. The particle size of metal particles of the metal catalyst layer is 1-6 nm. The metal catalyst loading of a metal catalyst layer is 0.005-0.30 mg/cm².

The present invention also provides a PEMFC, comprising a MEA as described above.

The present invention also provides a direct methanol fuel cell (DMFC), comprising a MEA as described above.

The main purpose of the present invention is to reduce the thickness of catalyst layer by replacing part of large metal-C catalyst particles with small nano metal catalyst particles and thus reduce the proton transport resistance in catalyst layers. Since the metal catalyst layer is thin, few metal catalyst particles aggregate in thin metal catalyst layer. Using structure-b, structure-c, and structure-d catalysts layers designs shown in FIG. 1, we reduced proton transport resistance in catalyst layers and maintained high Pt catalysis activity and thus improved PEM fuel cells performance. In FIGS. 1-b, 1-c, and 1-d, 506a, 506b, 506c, and 506d mean metal catalyst. Usually, the metal catalyst is Pt-black.

The main differences between structure-as MEA proposed by Srinvasan et al [E. A. Ticianelli, C. R. Derouin, S. Srinivasan, J. Electroanal Chem, 251, p. 275 (1988); S. Mukerjee, S. Srinivasan, A. J. Appleby, Electrochimica Acta, 38(12), p. 1661 (1993)] from the present invention, i.e. structure-b, structure-c, and structure-d MEAs, are: (1) The total Pt loadings of structure-b, structure-c, and structure-d MEAs are same as that of structure-a MEA, but the total Pt loading of structure-as MEA is larger than that of structure-a MEA; (2) Pt-black thin layers are fabricated either by coating, or brushing, or spraying a thin Pt-black ink layer on GDL and PEM in structure-b, structure-c, and structure-d MEAs, but the Pt thin layer is sputtered on PEM in structure-as MEA; (3) The thickness of Pt—C catalyst layer is reduced in structure-b, structure-c, and structure-d MEAs and their total catalysts layers thickness from Pt—C and Pt-layers is thinner than that of structure-a MEA. But, the thickness of Pt—C layer of structure-as MEA is same as that of structure-a MEA, thus the total catalyst layers thickness from Pt—C and sputtered Pt layers of structure-as MEA is thicker than that of structure-a MEA; (4) The Pt material and fabrication costs of structure-b, structure-c, and structure-d MEAs are cheaper than those of structure-as, because of low Pt loading and cheaper fabrication technique of structure-b, structure-c, and structure-d MEAs than structure-as MEA.

It is to be understood that both the foregoing general descriptions and the following detailed descriptions are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates the cross sections of MEAs. (1-a) structure-a, 5-layer conventional MEA; (1-b) structure-b, a 7-layer MEA; (1-c) structure-c, a 7-layer MEA; (1-d) structure-d, a 9-layer MEA.

FIG. 2 illustrates a flow chart of a Nafion-based PEMFC structure-b MEA fabrication process;

FIG. 3 illustrates the single cell test i-V curves of Nafion-based PEMFCs;

FIG. 4 illustrates a flow chart of a PBI-based PEMFC structure-b MEA fabrication process;

FIG. 5 illustrates the single cell test i-V curves of PBI-based PEMFCs;

FIG. 6 illustrates a flow chart of a Nafion-based DMFC structure-b MEA fabrication process; and

FIG. 7 illustrates the single cell test i-V curves of Nafion-based DMFCs.

### DESCRIPTION OF THE PREFERRED EMBODIMENTS

In the following examples, by controlling the sum of catalyst loading from metal-catalyst layers and metal-C catalyst layer of each MEA to be at a fixed value, the fuel cell performances of structure-b, structure-c, and structure-d MEAs were tested and compared with that of the conventional structure-a MEA. The metal catalyst was Pt-black (E-Tek Co, particles sizes ˜5.5 nm) and metal-C catalyst was Pt—C (E-Tek Co, Pt content 40 wt % and Pt particles sizes ˜2.9 nm). Using structure-a MEA as a reference, we prepared structure-b, structure-c, and structure-d MEAs by coating thin Pt-black catalyst layers at interfaces between Pt—C layer and GDL and/or between Pt—C layer and PEM and reducing Pt—C catalyst loading in Pt—C layer. The reduced amount of Pt loading at Pt—C layer was equal to the increased amount of Pt loading at Pt-black layer, thus the total Pt loadings of structure-b, structure-c, and structure-d MEAs were fixed and same as that of structure-a MEA.

Reference will now be made in detail to the present preferred embodiments of the invention, examples of which are illustrated in the accompanying drawings. Wherever possible, the same reference numbers are used in the drawings and the description to refer to the same or like parts.

### Embodiment-I

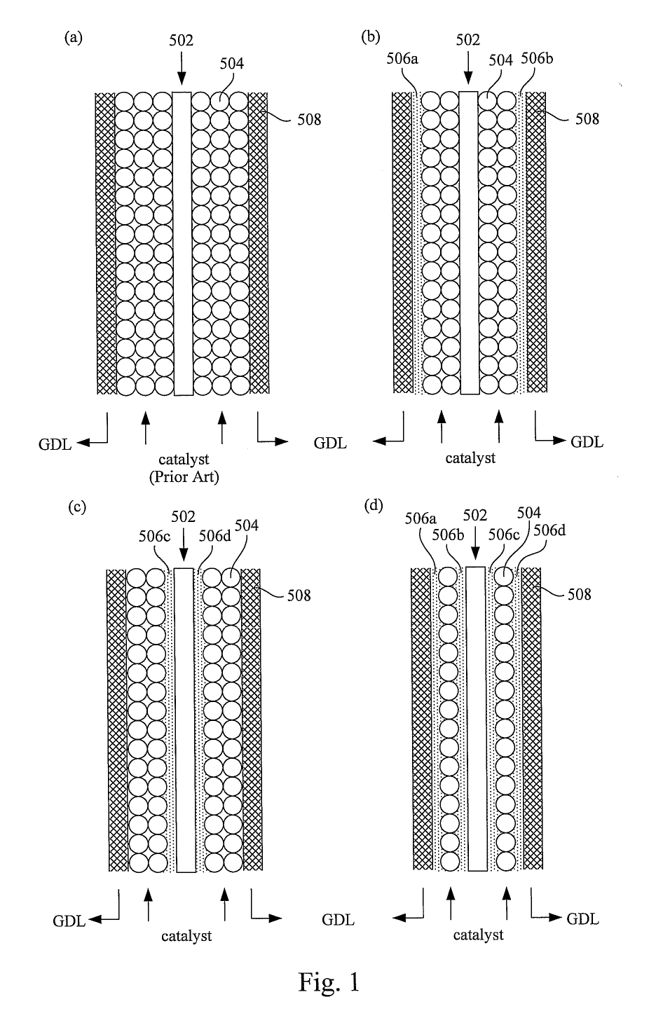

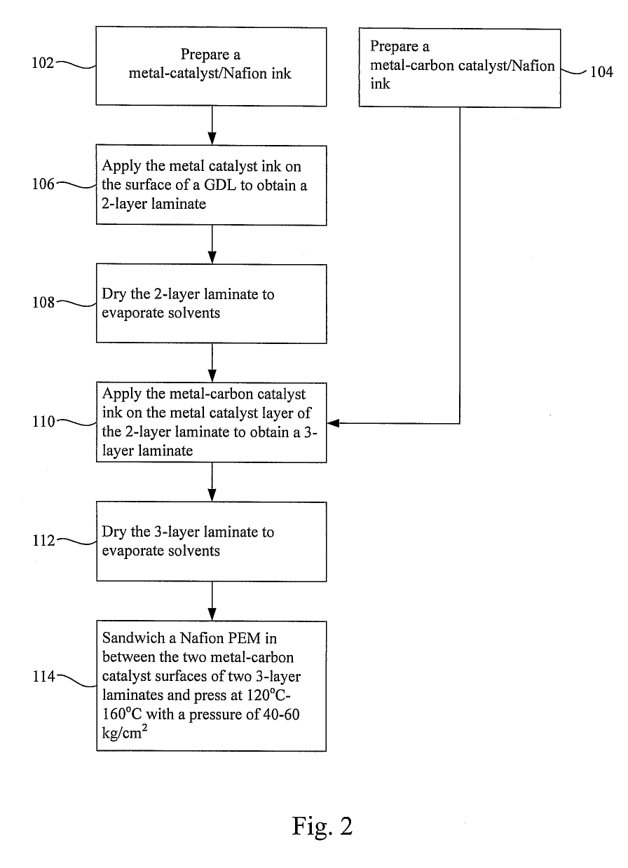

Refer to FIG. 2. In the embodiment, the structure-b MEA of FIG. 1-b prepared from Nafion-112 PEM (Du Pont Co) is adapted to exemplify and the detailed process is as follows.

A metal-catalyst ink was prepared by mixing metal-catalyst, Nafion resin, isopropyl alcohol, and water with a wt ratio of 3.0/1.0/6.5/624 and stirred by ultrasound to form a homogeneous mixture (step 102). A metal-carbon catalyst ink was prepared by mixing metal-carbon catalyst, Nafion resin, isopropyl alcohol, and water with a wt ratio of 2.0/1.0/6.5/624 and stirred by ultrasound to form a homogeneous mixture (step 104).

Next, the metal catalyst ink was coated on the surface of the carbon paper which was a GDL (step 106) to obtain a 2-layer laminate. After that, the 2-layer laminate was dried in air at ˜80° C. for 30 min and subsequently dried in vacuum at ˜80° C. for another 30 min. Thus a metal catalyst layer was formed on the surface of GDL (step 108). Next, the metal-carbon catalyst ink was coated on the surface of the metal catalyst layer of the 2-layer laminate prepared in step 108 (step 110). And, then the 3-layer laminate was dried in air at 80° C. for 30 min, and subsequently dried in vacuum at 80° C. for another 30 min. Thus a metal-carbon catalyst layer was formed on the surface of metal-catalyst layer (step 112). An electrode with a 3-layer laminar structure was then obtained at step 112. Then, a Nafion PEM was sandwiched in between the two metal-carbon catalyst layers of two 3-layer laminate electrodes obtained in step-112 so that the metal-carbon catalyst layers were attached on both surfaces of Nafion PEM to form a 7-layer laminar structure. Finally, the 7-layer laminate was pressed at 120-150° C. with a pressure of 40-60 kg/cm² for 30 sec and then with a pressure of 100 kg/cm² for 1 min (step 114) to obtain a structure-b MEA as shown in FIG. 1-b.

In embodiment-1, the Nafion resin (EW=1100) was a binder of catalysts both in metal catalyst and metal-carbon catalyst layers and a binder of catalyst layer with GDL and also a binder of catalyst layer with PEM. The PEM 502 was Nafion-112 (EW=1100, thickness ˜50 μm, Du Pont Co). The metal-carbon catalyst in 504 was Pt—C (Pt content 40 wt %, E-Tek Co), wherein the Pt—C particles sizes were ˜80 nm and the Pt particles sizes were ˜2-3 nm. The metal particles in metal catalyst layers 506a and 506b was Pt-black (particles sizes ˜5.5 nm, E-Tek Co). The GDL 508 was a carbon paper (SGL-31BC, SGL Co).

### PEMFC Performance Test of Embodiment-I

In order to compare PEMFC performance of structure-b MEA with that of the conventional structure-a MEA. One conventional structure-a MEA and three structure-b MEAs were prepared according to the fabrication procedure shown in FIG. 2.

The catalyst loadings of four MEAs are shown in Table I. In Table 1, the PEM is assumed to be located in the middle of MEA (i.e. between anode and cathode), and the loading of each catalyst layer on both sides of PEM is listed sequentially from PEM in the middle to the outside layer according to MEA structure. The structure designation of each MEA is also shown in Table 1. The designations of MEA structures are same as those shown in FIG. 1. MEA-1, a conventional structure-a MEA, was a reference and comprised only Pt—C catalysts. MEAs 2-4 comprised two Pt—C catalyst layers and two Pt-black catalyst layers, in which the two Pt—C catalyst layers were located at each side of Nafion membrane and Pt-black layers were located at the inner surfaces of GDLs. All the four MEAs had same total Pt loading (total Pt loading=[Pt-black loading]+40%×[Pt—C loading]), in spite of different loading combinations of Pt-black and Pt—C. Thus, the difference in testing results of various MEAs due to different Pt loading of each MEA can be excluded. The total Pt loading of each MEA was 0.5 mg/cm² at anode and 1.0 mg/cm² at cathode, as shown in Table 1.

TABLE 1
The catalysts loadings of PEMFC MEAs prepared from Nafion-112

| | | anode catalyst loading | | cathode catalyst loading | |
|---|---|---|---|---|---|
| | | (mg/cm²) | | (mg/cm²) | |
| MEA | MEA | Pt-black near | Pt—C | Pt—C | Pt-black |
| no. | structure | GDL | (40 wt % Pt) | (40 wt % Pt) | near GDL |
| 1 | a | — | 1.25 | 2.50 | — |
| 2 | b | 0.10 | 1.00 | 2.00 | 0.20 |
| 3 | b | 0.20 | 0.75 | 1.50 | 0.40 |
| 4 | b | 0.30 | 0.50 | 1.00 | 0.60 |

| | | |
|---|---|---|
| total Pt loading | 0.50 | 1.00 |

The thickness of each MEA is shown in Table 2. Table 2 shows MEA thickness was reduced when part of the large Pt—C particles layer was replaced by a small Pt-black particles layer. The thickness of MEA-2-MEA-4 was from 425 μm to 380 μm. Comparing with the thickness 470 μm of MEA-1, the thickness of MEA-2, -3, and -4 was thinner than that of MEA-1.

TABLE 2
OCV, PDₘₐₓ, Rᵢ, and thickness of MEAs prepared from Nafion-112
(catalyst loadings are shown in Table 1)

| | OCV | PDₘₐₓ | Rᵢ at i = 400 mA | thickness of MEA |
|---|---|---|---|---|
| MEA no. | (V) | (mW/cm²) | (Ωcm²) | (μm) |
| 1 | 0.97 | 340 | 0.34 | 470 |
| 2 | 0.99 | 462 | 0.16 | 425 |
| 3 | 0.97 | 402 | 0.21 | 400 |
| 4 | 0.95 | 200 | 0.45 | 380 |

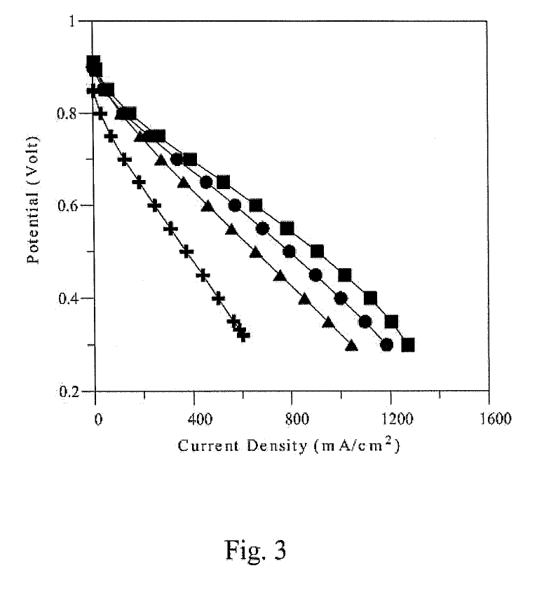

The single cell tests of MEAs 1-4 were carried out using a Globe Tech Computer Cell GT system (Electrochem Inc.) at 80° C. The inlet hydrogen and oxygen flow rates were 200 ml/min with a back pressure of 1 atm. The active area of each MEA was 5×5 cm². Before cell voltage V versus current density i curve (i.e. i-V curve) was collected, the cell was activated for 3 hr to enhance humidification and activation of MEA. i-V curves were obtained by measuring i with step decrement of voltage by an interval of 0.05 V. The i-V curves of these four MEAs are shown in FIG. 3. In FIG. 3, (▴) represented MEA-1, (▪) represented MEA-2, () represented MEA-3, and (+) represented MEA-4. The single cell test OCV (open circuit voltage) and PDₘₐₓ (maximum power density, where power density PD=V×i) data of four MEAs are shown in Table 2.

In an ideal reversible fuel cell, the output voltage should be a fixed value when current is generated. However, the transport resistance of proton from the surfaces of anode catalysts through PEM to the surface of cathode catalysts causes internal resistance when current is generated from a fuel cell. The potential loss due to the resistance of proton transport in MEA is the so called “Ohmic polarization”, which causes a decrease of voltage, and contributes most of voltage loss at middle current density region of i-V curves. Accordingly, the negative slope at the middle current density region (i=300-600 mA/cm² in FIG. 3) of an i-V curve, is proportional to internal resistance Rᵢ of a MEA. In addition to single cell test, the current interrupt tests were also performed to measure Rᵢ of MEA at i=400 mA/cm². The Rᵢ data of four MEAs at i=400 mA/cm² are also listed in Table 2.

Since all of the four MEAs comprised same PEM, i.e. Nafioin-112, contribution of PEM resistance to Rᵢ was same in each of these four MEAs. Therefore, the difference in Rᵢ among these four MEAs mainly resulted from the difference in the resistance of catalyst layers. The Rᵢ data at i=400 mA/cm² (Table 2) and the negative slopes of Ohmic polarization region of i-V curves (FIG. 3) revealed that MEA-2 and MEA-3 had lower Rᵢ than MEA-1. These results revealed that at a fixed “total Pt loading”, the Rᵢ could be reduced by replacing part of Pt—C catalyst layer with a thinner Pt-black catalyst layer, which resulted in a decrease of the thickness of catalyst layer and led to the reduction of the proton transport path length in MEA.

Although the Rᵢ of a MEA can be reduced by replacing part of Pt—C layer with a thin Pt-black layer to lower the thickness of the catalyst layers, it does not imply that Rᵢ of a MEA can be reduced substantially by replacing Pt—C catalysts with lots of Pt-black catalysts. According to Table 1, the Pt-black replacing loading in MEA-4 was larger than in MEA-2 and MEA-3. However, the negative slope of Ohmic polarization region of the i-V curve of MEA-4 was larger than those of MEA-2 and MEA-3, indicating that MEA-4 had a larger Rᵢ. Therefore, there should be an optimum loading ratio of Pt-black to Pt—C for a high performance MEA. Rᵢ increases with increasing Pt-black loading when the Pt-black replacing loading was above the optimum Pt-black loading. The high thickness of Pt-black layer causes aggregations of Pt-black particles and results in the decreasing of Pt catalysis active surface area. Moreover, some of the Pt-black particles inside the agglomerations may not in contact with Nafion resin, which causes an interruption of proton transport and an increase in Rᵢ. Another reason for the lower fuel cell performance of MEA-4 than MEA-2 and MEA-3 could be attributed to the blockage of H₂ and O₂ flow at the interface of GDL and Pt-black layer by a thick layer consisting of small Pt-black particles.

### Embodiment-II

To further investigate the influence of replacing large particle Pt—C catalyst layer by a thin layer of small particulate Pt-black catalyst on the PEMFC performance, eight MEAs including structures -a, -b, -c, and -d MEAs of FIG. 1 were prepared. And, single cell tests were carried out to observe the PEMFC performances of these MEAs. Our intention was to compare PEMFC performances of different MEAs with various catalyst layer structures. The Pt-black catalyst (506a, 506b, 506c, and 506d of FIG. 1), Pt—C catalyst (504 of FIG. 1), and GDL (508 of FIG. 1) were same as those described in Embodiment-I, except the PEM (502 of FIG. 1). In this embodiment, the PEM was Nafion-212, which was a second generation PEM of Du Pont Co. According to Du Pont Co, Nafion-212 has same thickness and same EW as Nafion-112 (EW=1100, thickness 50 μm), but has a higher elongation and a higher water uptake than Nafion-112.

The catalyst loadings and structure designations of these eight MEAs are summarized in Table 3. In Table 3, the PEM is assumed to be located in the middle of an MEA, i.e. between anode and cathode, and the loading of each catalyst layer on both sides of PEM is listed sequentially from PEM in the middle to the outside layer according to each MEA structure shown in FIG. 1. All the eight MEAs had same total Pt loading, in spite of different loading combinations of Pt-black and Pt—C. Thus, the difference in testing results of various MEAs due to the difference in Pt loadings can be excluded. The total Pt loading of each MEA was 0.5 mg/cm² at anode and 1.0 mg/cm² at cathode, as shown in Table 3.

The procedures for preparing each MEA were similar to those described in embodiment-I, except the catalyst loadings and structures of catalyst layers. The structure-a (FIG. 1-a) MEA-1 was a reference, comprised only Pt—C catalyst layers 504 located between PEM 502 and GDL 508. The structure-b (FIG. 1-b) MEAs 2, 4, and 6 comprised Pt-black and Pt—C catalyst layers, wherein the Pt-black layers 506a and 506b were located between GDL 508 and Pt—C layer 504. Structure-c (FIG. 1-c) MEAs 3 and 5 comprised Pt-black and Pt—C layers wherein the Pt-black catalyst layers 506c and 506d were located between Pt—C catalyst layers 504 and PEM 502. Structure-d MEAs 7 and 8 comprised two Pt-black catalyst layers and two Pt—C catalyst layers, wherein two Pt-black catalyst layers 506b and 506c were located between Pt—C catalyst layers 504 and PEM 502, and the other two Pt-black catalyst layers 506a and 506d were located between GDL layers 508 and Pt—C catalyst layers 504. Thickness of each MEA was listed in Table 4. Table 4 shows that the MEA thickness was reduced when part of large particle Pt—C catalyst was replaced by small particulate Pt-black catalyst.

TABLE 3
The catalysts loadings MEAs prepared from Nafion-212.

| | | | | | cathode catalyst loading | | |
|---|---|---|---|---|---|---|---|
| | | anode catalyst loading | | | (mg/cm²) | | |
| | | (mg/cm²) | | | | | Pt- |
| | | Pt-black | Pt—C | Pt-black | Pt-black | Pt—C | black |
| MEA | MEA | near | (Pt 40 | near | near | (Pt 40 | near |
| no. | structure | GDL | wt %) | member | member | wt %) | GDL |
| 1 | a | — | 1.25 | — | — | 2.5 | — |
| 2 | b | 0.05 | 1.125 | — | — | 2.375 | 0.05 |
| 3 | c | — | 1.125 | 0.05 | 0.05 | 2.375 | — |
| 4 | b | 0.10 | 1.00 | — | — | 2.25 | 0.10 |
| 5 | c | — | 1.00 | 0.10 | 0.10 | 2.25 | — |
| 6 | b | 0.20 | 0.75 | — | — | 2.00 | 0.20 |
| 7 | d | 0.10 | 0.75 | 0.10 | 0.10 | 2.00 | 0.10 |
| 8 | d | 0.05 | 1.00 | 0.05 | 0.05 | 2.25 | 0.05 |

| | | |
|---|---|---|
| total Pt loading | 0.50 | 1.00 |

### PEMFC Performance Test of Embodiment-II

The PEMFC single cell performances tests of these eight MEAs were carried out under the same testing conditions as those described in the embodiment-I. The PEMFC test results, i.e. OCV, PDₘₐₓ, and Rᵢ at i=400 mA/cm², are summarized in Table 4.

Furthermore in Table 4, by comparing the testing results of structure-a MEA-1 with those of structure-b MEA-2 and MEA-4, and also comparing the results of structure-a MEA-1 with those of structure-c MEA-3 and MEA-5, we found that Rᵢ decreased and PDₘₐₓ increased when Pt-black replacing loading was increased from 0.0 mg/cm² to 0.1 mg/cm². However, Table 4 also shows that Rᵢ increased and PDₘₐₓ decreased when the Pt-black replacing loading in structure-b MEA was increased from 0.1 mg/cm² (MEA-4) to 0.2 mg/cm² (MEA-6). The improvement of fuel cell performance as the Pt-black replacing loading was increased from 0.0 mg/cm² to 0.1 mg/cm² could be attributed to the reduction of catalyst layer thickness, which reduced proton transport path length in catalyst layers and led to the reduction of Rᵢ of MEAs. The fuel cell performance became worse when the Pt-black replacing loading in structure-b MEA was increased from 0.1 mg/cm² to 0.2 mg/cm² could be attributed to the agglomeration of Pt-black particles in Pt-black layer, because of large amount of Pt-black particles cumulated in a layer. The agglomeration of Pt particles reduces Pt catalytic surface area. Agglomeration of Pt particles may also cause some Pt particles buried inside the agglomeration particles, which may not in contact with Nafion resin leading to the interruption of proton transport in the catalyst layer.

Referring to the PEMFC performances of structure-d MEAs. Table 3 shows that structure-d MEA-7 has same Pt-black and Pt—C loadings as structure-b MEA-6. But the Pt-black loading in MEA-7 was divided into two layers with one layer located next to PEM and the other layer next to GDL, rather than with only one Pt-black layer located near GDL as in MEA-6. Table 4 shows that MEA-7 had a higher PDₘₐₓ than MEA-6, and a similar Rᵢ to MEA-6. Similarly, structure-d MEA-8 had same Pt-black and Pt—C loadings as structure-b MEA-4 and structure-c MEA-5 (Table 3), but Table 4 also shows MEA-8 had a higher PDₘₐₓ than MEA-4 and MEA-5 and a similar Rᵢ to MEA-4 and MEA-5. It is obvious that under a fixed Pt-black replacing loading, a double Pt-black layers structure-d has a better fuel cell performance than single Pt-black layer structure-b and structure-c, due to the lower thickness of the Pt-black layer in structure-d than in-structure-b and structure-c. Thus a less agglomeration and higher catalysis surface area of Pt-black particles in structure-d MEA than in structure-b and structure-c MEAs. Furthermore comparison of the fuel cells performances of all the MEAs, we found that MEA-5 and MEA-8 had a higher PDₘₐₓ than other MEAs, suggesting the preferred Pt-black replacing loading was around 0.1 mg/cm² both at anode and cathode.

TABLE 4
OCV, PDₘₐₓ, Rᵢ, and thickness of MEAs prepared from Nafion-212
(catalyst loadings are shown in Table 3)

| | OCV | PDₘₐₓ | Rᵢ at i = 400 mA | thickness of |
|---|---|---|---|---|
| MEA no. | (V) | (mW/cm²) | (Ωcm²) | MEA (μm) |
| 1 | 0.96 | 450 | 0.130 | 461 |
| 2 | 0.94 | 480 | 0.111 | 447 |
| 3 | 0.94 | 490 | 0.114 | 454 |
| 4 | 0.95 | 500 | 0.102 | 435 |
| 5 | 0.94 | 550 | 0.103 | 440 |
| 6 | 0.96 | 420 | 0.131 | 413 |
| 7 | 0.95 | 470 | 0.130 | 407 |
| 8 | 0.98 | 554 | 0.104 | 431 |

### Embodiment-III

Since MEAs prepared from Nafion are mainly used for low temperature operation fuel cells (temperature below 90° C.). Therefore, in this embodiment, MEAs prepared from polybenzimidazole (PBI) for high temperature operation fuel cells (temperature around 130-200° C.) are provided. The structure-b PBI-based MEAs were presented as examples in this embodiment. The structure-c and structure-d PBI-based MEAs can be prepared following similar procedures described in this embodiment.

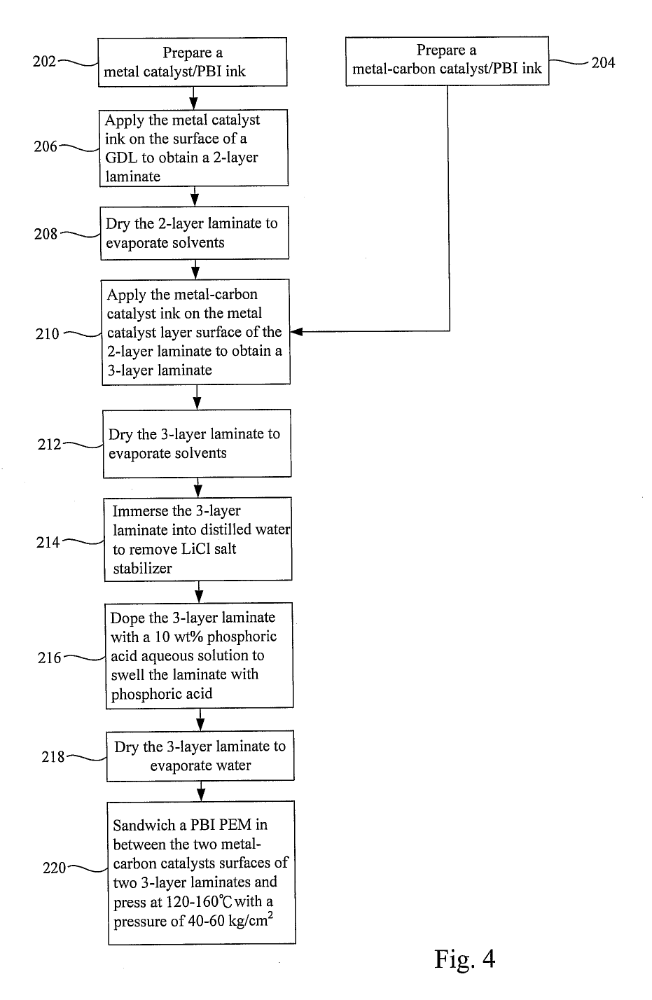

Refer to FIG. 4. FIG. 4 illustrates a flow chart of the fabrication process of a PBI-based structure-b MEA. First, a metal-catalyst/PBI ink was prepared by mixing metal catalyst, PBI, N,N-dimethylacetamide (DMAc), and LiCl in a wt ratio of 4.0/1.0/49.0/0.3 with an ultrasonic disturbing for 5 hr (step 202). Moreover, the metal-carbon catalyst/PBI ink was prepared by mixing metal-carbon catalyst, PBI, DMAc, and LiCl in a wt ratio of 3.5/1.0/49.0/0.3 with an ultrasonic mixer for 5 hr (step 204). Next, the metal catalyst ink prepared in step 202 was coated on the surface of a GDL (step 206). After that, the 2-layer laminate was dried at 110° C. for 30 min to evaporate solvents and caused the formation of a metal catalyst layer on GDL (step 208). Next, the metal-carbon catalyst ink prepared in step 204 was coated on the surface of the metal catalyst layer of the 2-layer laminate prepared in step 208 (step 210). Then the 3-layer laminate was dried at 110° C. for 30 min to evaporate solvent and caused the formation of metal-carbon catalyst layer on the surface of metal catalyst layer (step 212). After that, the 3-layer laminate was immersed into deionized water for 10 hr wherein water was changed every 2 hr to remove LiCl (step 214). Next, the 3-layer laminate obtained at step 214 was doped in 10 wt % phosphoric acid aqueous solution for 24 hr (step 216) and then dried at 110° C. for 60 min (step 218). Next, a PBI PEM was sandwiched in between the two metal-carbon catalyst layers of two 3-layer laminate electrodes obtained at step 218 so that both sides of PBI PEM were in contact with the metal-carbon catalyst layers of electrodes to form a 7-layer laminar structure. Finally the 7-layer laminate was pressed at 140-160° C. with a pressure of 40-60 kg/cm² (step 220) for 5 min to obtain a PBI based structure-b MEA as shown in FIG. 1-b.

In the embodiment, DMAc was a solvent and LiCl was a stabilizer for preparing catalyst/PBI ink. In catalyst layers, PBI resin was a binder of catalysts with GDL and with PEM. PBI also provided polar functional groups for proton transport. The thickness of PBI PEM in this embodiment was ˜80 μm. The metal catalyst and metal-carbon catalyst were Pt-black and Pt—C (Pt content 40 wt %), respectively, which were same as those described in embodiments I and II. The GDL was a carbon cloth (HT 2500-W, E-Tek Co).

### PEMFC Single Cell Performance Tests of Embodiment III

In order to compare PEMFC performance of the PBI-based structure-b MEA with that of the conventional PBI-based structure-a MEA. One structure-a MEA and two structure-b MEAs were prepared from PBI according to the fabrication procedures shown in FIG. 4.

The catalyst loadings of these three MEAs are shown in Table 5. In Table 5, the PEM is assumed to be located in the middle of a MEA, i.e. between anode and cathode, and the loading of each catalyst layer on both sides of PEM is listed sequentially from PEM in the middle to the outside layer according to MEA structure shown in FIG. 1. The structure designation of each MEA is also shown in Table 5. The designations of MEA structures are same as those shown in FIG. 1. MEA-1, a conventional structure-a MEA, was a reference and comprised only Pt—C catalysts. MEA-2 and MEA-3 comprised two Pt—C catalyst layers and two Pt-black catalyst layers, in which the two Pt—C catalyst layers were located at each side of PBI membrane surface and Pt-black layers were located at the inner surfaces of GDLs. All the three MEAs had same total Pt loading, in spite of different loading combinations of Pt-black and Pt—C. Thus, the difference in testing results of various MEAs due to difference in Pt loading of each MEA can be excluded. The total Pt loading of each MEA was 0.5 mg/cm² at anode and 1.0 mg/cm² at cathode, as shown in Table 5.

TABLE 5
The catalysts loadings of MEAs prepared from PBI.

| | | anode catalyst loading | | cathode catalyst loading | |
|---|---|---|---|---|---|
| | | (mg/cm²) | | (mg/cm²) | |
| MEA | MEA | Pt-black near | Pt—C | Pt—C | Pt-black |
| no. | structure | GDL | (Pt 40 wt %) | (Pt 40 wt %) | near GDL |
| 1 | a | — | 1.25 | 2.50 | — |
| 2 | b | 0.10 | 1.00 | 2.25 | 0.10 |
| 3 | b | 0.10 | 1.00 | 2.0 | 0.20 |

| | | |
|---|---|---|
| total Pt loading | 0.50 | 1.00 |

The thickness of each MEA is also shown in Table 6. Table 6 shows MEA thickness was reduced when part of large Pt—C particles layer were replaced by small Pt-black particles layer. The thicknesses of MEA-2 and MEA-3 were 572 μm and 560 μm, respectively. Comparing with the thickness 587 μm of MEA-1, we found the thicknesses of MEA-2 and MEA-3 were thinner than MEA-1.

TABLE 6
OCV, PDₘₐₓ, Rᵢ, and thickness of MEAs prepared from PBI (catalyst
loadings are shown in Table 5)

| | OCV | PDₘₐₓ | Rᵢ at i = 400 mA | thickness of |
|---|---|---|---|---|
| MEA no. | (V) | (mW/cm²) | (Ωcm²) | MEA (μm) |
| 1 | 0.72 | 152 | 0.35 | 587 |
| 2 | 0.71 | 200 | 0.28 | 572 |
| 3 | 0.71 | 177 | 0.30 | 560 |

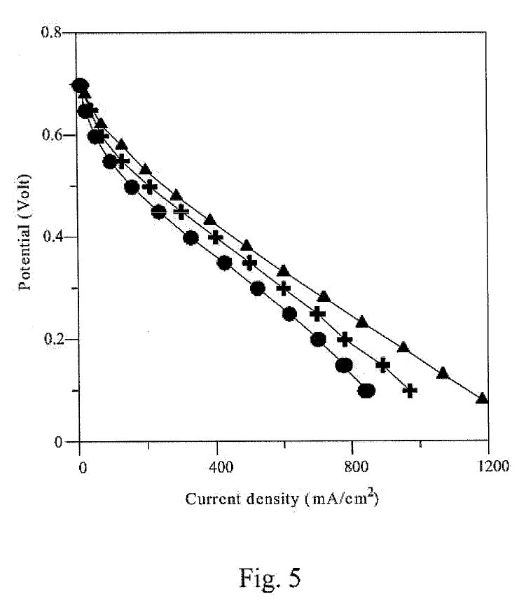

The single cell tests of MEAs 1-3 were carried out at 160° C. using a FC5100 fuel cell testing system (Chino Inc., Japan). The inlet hydrogen and oxygen flow rates were 300 ml/min with a back pressure of 1 atm. The active area of each MEA was 5×5 cm². Before a i-V curve was collected, the cell was activated for 10 hr to enhance humidification and activation of MEA. i-V curves were obtained by measuring i with step decrement of voltage by an interval of 0.05 V. The i-V curves of these three MEAs are shown in FIG. 5. In FIG. 5, () represented MEA-1, (▴) represented MEA-2, and (+) represented MEA-3. The single cell OCV and PDₘₐₓ data of these MEAs are also shown in Table 6. The current-interrupt method was also carried out to measure Rᵢ of each MEA at i=400 mA/cm². The Rᵢ data at i=400 mA/cm² of these three MEAs are also listed in Table 6.

Table 6 and FIG. 5 revealed that MEA-2 and MEA-3 had lower Rᵢ and higher fuel cell performance than MEA-1. These results revealed that at a fixed “total Pt loading”, the Rᵢ could be reduced by replacing part of large Pt—C particle catalyst layer with a small Pt particle catalyst thin layer, which resulted in the decrease of the thickness of catalyst layer and led to the reduction of the proton transport path length In catalyst layer and improved fuel cell performance.

### Embodiment IV

In this embodiment, the MEA structures designs of present invention were applied to direct methanol fuel cells (DMFC). The structure-b MEA was used as an example to compare its DMFC performance with the conventional structure-a MEA. In the following section, the procedures for preparing structure-b DMFC MEA are described. The preparations of structure-c and structure-d DMFC MEAs are similar to the procedures described in this embodiment.

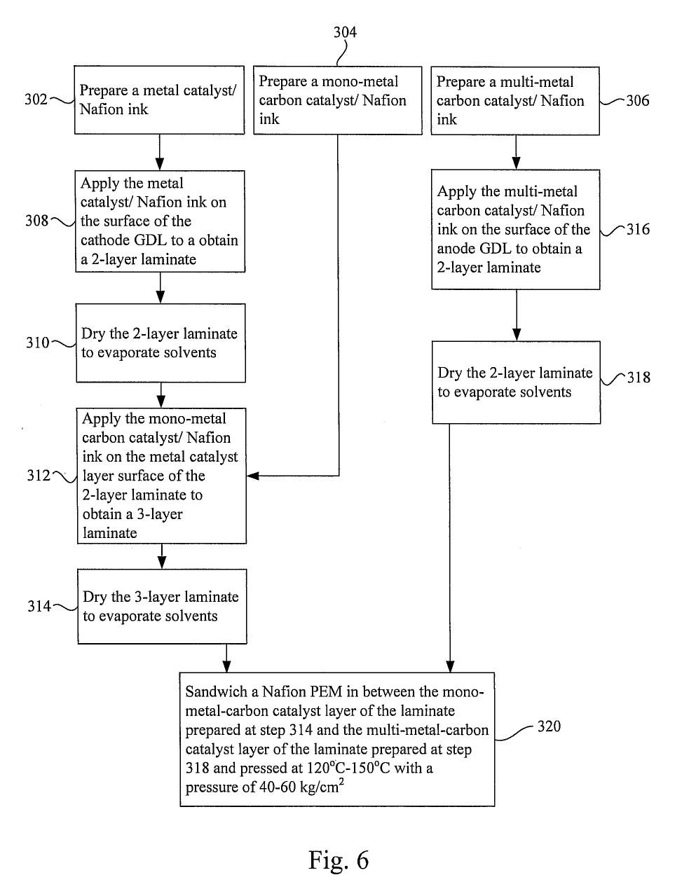

Refer to FIG. 6 illustrates a flow chart of a DMFC MEA fabrication process, according to structure-b of FIG. 1 of the present invention. A metal catalyst ink, a mono-metal-carbon catalyst ink, and a multi-metal-carbon catalyst ink were prepared. Wherein, the metal catalyst ink was prepared by mixing metal catalyst, Nafion resin (EW=1100), isopropyl alcohol, and water with a weight ratio of 3.0/1.0/6.5/624, respectively, (step 302). The mono-metal-carbon catalyst ink was prepared by mixing mono-metal-carbon catalyst, Nafion, isopropyl alcohol, and water with a weight ratio of 2.0/1.0/6.5/624, respectively, (step 304). The multi-metal-carbon catalyst ink was prepared by mixing multi-metal-carbon catalyst, Nafion, isopropyl alcohol, and water with a weight ratio of 2.0/1.0/6.5/624, respectively, (step 306).

Next, the metal catalyst ink was coated on the surface of a carbon paper which was the GDL of a cathode (step 308). After that, the laminate was dried at 80° C. for 30 min to evaporate solvents to obtain a 2-layer laminar structure with the metal catalyst layer on the surface of the GDL of the cathode (step 310). Next, the mono-metal-carbon catalyst ink (prepared at step 304) was coated on the surface of the metal catalyst layer of the 2-layer laminate prepared at step 310 (step 312), and then dried at 80° C. for 30 min to obtain a 3-layer laminate with the mono-metal-carbon catalyst layer on the surface of metal catalyst layer (step 314). Moreover, the multi-metal-carbon catalyst ink (prepared at step 306) was coated on the surface of a carbon paper which was the GDL of an anode to obtain a 2-layer laminate (step 316). After that, the 2-layer laminate was dried at 80° C. for 30 min to evaporate solvents and led the formation of a multi-metal-carbon catalyst layer on the surface of the GDL of an anode (step 318). Finally, a Nafion PEM was sandwiched in between the mono-metal-carbon catalyst layer of a 3-layer laminate cathode prepared at step 314 and the multi-metal-carbon catalyst layer of a 2-layer laminate anode prepared at step 318. The whole laminar structure was then hot pressed at 130° C. with 40-60 kg/cm² for 30 sec and followed with 100 kg/cm² for 1 min (step 320).

In this embodiment, the PEM was Nafion-117 (thickness 175 μm). The metal catalyst was Pt-black (particle size ˜5.5 nm, E-TEK Co). The mono-metal-carbon catalyst was Pt—C (40 wt % Pt, E-Tek Co). The multi-metal-carbon catalyst was Pt—Ru—C (20 wt % Pt, 20 wt % Ru, E-Tek Co). The GDL was a carbon paper (SGL-31BC, SGL Co).

### DMFC Single Cell Performance Test of Embodiment IV

In order to compare DMFC performance of the structure-b MEA with that of the conventional structure-a MEA. One structure-a MEA and two structure-b MEAs were prepared according to the fabrication procedures shown in FIG. 6.

The catalyst loadings of three MEAs are shown in Table 7. In Table 7, the PEM is assumed to be located in the middle, i.e. between anode and cathode, and the loading of each catalyst layer on both sides of PEM is listed sequentially from PEM in the middle to the outside layer according to MEA structure shown in FIG. 1. The structure designation of each MEA is also shown in Table 7. The designations of MEA structures are same as those shown in FIG. 1. MEA-1, a conventional structure-a MEA, was a reference and comprised only Pt—C catalyst at cathode and Pt—Ru—C at anode. MEAs 2 and 3 comprised one Pt—C catalyst layer and one Pt-black catalyst layer at cathode, in which Pt—C catalyst layer was located next to one side of Nafion membrane and the Pt-black layer was located next to the inner surface of a GDL. The anodes of MEAs 2 and 3 comprised only a Pt—Ru—C catalyst layer.

All the three MEAs had same total Pt loading, in spite of different loading combinations of Pt-black and Pt—C. Thus, the difference in testing results of various MEAs due to difference in Pt loading of each MEA can be excluded. The total Pt loading of each MEA was 2.0 mg/cm² both at anode and cathode, as shown in Table 7.

TABLE 7
Catalysts loadings of DMFC MEAs prepared from Nafion-117.

| | | anode catalyst loading | cathode catalyst loading | |
|---|---|---|---|---|
| | | (mg/cm²) | (mg/cm²) | |
| MEA | MEA | Pt—Ru—C | Pt—C | Pt-black |
| no. | structure | (Pt 20 wt %; Ru 20 wt %) | (Pt 40 wt %) | near GDL |
| 1 | a | 10.0 | 5.0 | — |
| 2 | b | 10.0 | 4.75 | 0.10 |
| 3 | b | 10.0 | 4.50 | 0.20 |

| | | |
|---|---|---|
| total Pt loading | 2.00 | 2.00 |

The thickness of each MEA is shown in Table 8. Table 8 shows MEA thickness was reduced when part of large Pt—C particles layer was replaced by small Pt-black particles thin layer. The thickness of MEA-2 and MEA-3 was 858 μm and 833 μm, respectively. Comparing with MEA-1, Table 8 shows MEA-2 and -3 were thinner than MEA-1.

TABLE 8
OCV and Rᵢvalues of DMFC MEAs prepared from Nafion-117 (catalyst
loadings are shown in Table 7)

| | OCV | PDₘₐₓ | Rᵢ at i = 400 mA | thickness of |
|---|---|---|---|---|
| MEA no. | (V) | (mW/cm²) | (Ωcm²) | MEA (μm) |
| 1 | 0.81 | 17.8 | 1.0 | 872 |
| 2 | 0.75 | 24.2 | 0.7 | 858 |
| 3 | 0.66 | 17.4 | 1.0 | 833 |

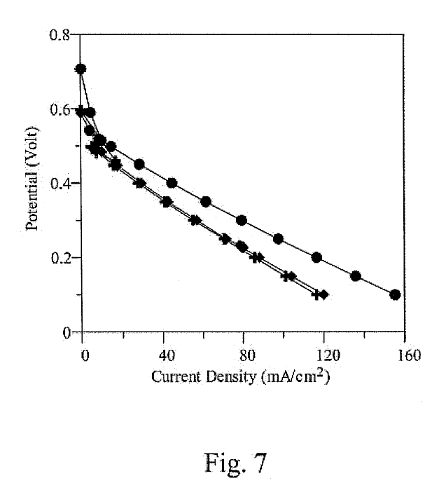

The DMFC performance tests of these three MEAs were carried out at 80° C. using a Globe Tech Computer Cell GT system (Electrochem Inc.). The anode input was a 2.0 M methanol aqueous solution with a flow rate of 5.0 ml/min. The cathode input oxygen gas flow rate was 150 ml/min. The active area was 5×5 cm². Before i-V curve was collected, the cell was activated for 3 hr to enhance humidification and activation of MEA. i-V curves were obtained by measuring i with step decrement of voltage by an interval of 0.05 V. The time was held 20 sec for each measurement. The i-V curves are shown in FIG. 7. In FIG. 7, (♦) represented MEA-1, () represented MEA-2, and (+) represented MEA-3. The OCV and PDₘₐₓ data of these MEAs are listed in Table 8. The current-interrupt experiments were also carried out to measure Rᵢ of each MEA at i=40 mA/cm². The Rᵢ data are also shown in Table 8.

Table 8 and FIG. 7 revealed that MEA-2 had lower Rᵢ and higher fuel cell performance than MEA-1. These results revealed that at a fixed “total Pt loading”, the Rᵢ could be reduced by replacing part of large particulate Pt—C catalyst layer at cathode by a thin layer of small Pt-black particles. The replacement of Pt—C catalyst by Pt-black catalyst resulted in a decrease of the thickness of catalyst layer and led to the reduction of the proton transport path length in the MEA and thus reduced Rᵢ of MEA.

However, as the replacement of Pt—C with Pt-black was increased to 10 wt % (MEA-3), the DMFC performance was similar to conventional structure-a MEA-1. The reason for the worse DMFC performance of MEA-3 than MEA-2 could be attributed to the cumulate of lots of nano-Pt particles on porous GDL, which caused blockages of input oxygen gas flow and drainage of water in cathode. Moreover, cumulating lots of Pt-black particles in a layer might also cause agglomeration of Pt particles, which resulted in decreasing of catalysis active surface area and lowered the OCV value. Furthermore, some of Pt particles buried inside the agglomerations might not in touch with Nafion resin, leading to the termination of proton transport and the increase of Rᵢ.

In conclusion, replacing part of large sizes metal-carbon catalyst layer with small sizes metal catalyst layer in MEA reduces thickness of catalyst layer, leading to the reduction of internal resistance of a MEA. In addition, the catalysis specific active surface area can be maintained at a high value while the replacing loading of nano metal catalyst is below the critical value. Moreover, the MEA prepared by the above mentioned methods can be applied to PEMFCs and DMFCs.

It will be apparent to those skill in the art that various modifications and variations can be made to the structure of the present invention without departing from the scope or spirit of the invention. In view of the foregoing, it is intended that the present invention covers modifications and variations of this invention provided, they fall within the scope of the following claims and their equivalents.

What is claimed is:

1. A membrane electrode assembly, comprising:
a proton exchange membrane;
at least two metal-carbon catalyst layers, located on both sides of the proton exchange membrane;
two gas diffusion layers attached on the two outer sides of the metal-carbon catalyst layers; and
at least one metal catalyst layer, located at the interface between the proton exchange membrane and the metal-carbon catalyst layer and/or at the interface between the metal-carbon catalyst layer and the gas diffusion layer.

2. The membrane electrode assembly of claim 1, wherein the proton exchange membrane is: Nafion, polybenzoimidazole (PBI), sulfonated poly(ether ketone), sulfonated poly(ether ether ketone), sulfonated polyimide, sulfonated polysulfone, or other polyelectrolytes.

3. The membrane electrode assembly of claim 1, wherein the thickness of the proton exchange membrane is 5-200 μm.

4. The membrane electrode assembly of claim 1, wherein the metal-carbon catalyst layer is a mono-metal-carbon catalyst or a multi-metal-carbon catalyst.

5. The membrane electrode assembly of claim 4, wherein the particles sizes of the mono-metal-carbon catalyst or the multi-metal-carbon catalyst are 40-150 nm.

6. The membrane electrode assembly of claim 4, wherein the multi-metal-carbon catalyst comprises a carbon particle with metal particles dispersed on the surface of the carbon particle wherein the metal particles comprise at least two kinds of metal elements.

7. The membrane electrode assembly of claim 6, wherein the metal particles of the multi-metal-carbon catalyst are selected from the group consisting of platinum, gold, cobalt, iron, rubidium, nickel, silver, palladium and a combination thereof.

8. The membrane electrode assembly of claim 4, wherein the mono-metal-carbon catalyst comprises a carbon particle with metal particles dispersed on the surface of the carbon particle wherein the metal particles comprise only one kind of metal element.

9. The membrane electrode assembly of claim 8, wherein the metal particles of the mono-metal-carbon catalyst are platinum.

10. The membrane electrode assembly of claim 4, wherein the particle sizes of the metal particles of the mono-metal-carbon catalyst and the multi-metal-carbon catalyst are 1.0-6.0 nm.

11. The membrane electrode assembly of claim 1, wherein the metal catalyst layer comprises metal particles, and the metal particles of the metal catalyst layer are one kind of metal elements or more than one kind of metal elements.

12. The membrane electrode assembly of claim 11, wherein the metal particles of the metal catalyst layer are selected from the group consisting of platinum, gold, cobalt, iron, rubidium, silver, palladium, and a combination thereof.

13. The membrane electrode assembly of claim 12, wherein the metal particles of the metal catalyst layer are platinum.

14. The membrane electrode assembly of claim 1, wherein the particle size of metal particles of the metal catalyst layer is 1-6 nm.

15. The membrane electrode assembly of claim 1, wherein the metal catalyst loading of a metal catalyst layer is 0.005-0.30 mg/cm².

16. The membrane electrode assembly of claim 1, wherein the gas diffusion layers are either porous carbon cloth or porous carbon paper.

17. A proton exchange membrane fuel cell (PEMFC), comprising a membrane electrode assembly as described in claim 1.

18. A direct methanol fuel cell (DMFC), comprising a membrane electrode assembly as described in claim 1.
